(19) United States
(12) Patent Application Publication
(10) Pub. No.: US 2007/0058952 A1
(43) Pub. Date: Mar. 15, 2007

(54) METHOD OF AUTOMATIC CHAPTER INSERTION AND DIGITAL VERSATILE DISC RECORDER THEREOF

(76) Inventors: Chien-Ju Liu, Hsin-Chu City (TW); Chun-Hsiung Hu, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/162,573

(22) Filed: Sep. 15, 2005

(51) Int. Cl. H04N 5/00

(52) U.S. Cl. 386/126

(57) ABSTRACT

A digital versatile/video (DVD) recorder includes a packet extractor being coupled to an incoming video signal for detecting control packets in the incoming video signal, a record start monitor being coupled to the packet extractor for monitoring a field of the control packets detected by the packet extractor, and outputting corresponding start point information according to the field, and a chapter mark insertion unit being coupled to the record start monitor for inserting chapter marks on a DVD disc being coupled to the DVD recorder when recording video onto the DVD disc according to the start point information outputted by the record start monitor. When recording video content from a DV camera, a new chapter mark is inserted on the DVD disc for each movie on the DV camera and can be used to easily find the beginning of each movie when playing the DVD disc.

### BACKGROUND

The invention relates to recording audio/video content on a digital versatile/video disc (DVD), and more particularly, to automatically inserting chapter marks on a DVD while recording different movies from a DV tape.

Digital Video (DV) is a video format launched in 1996, which encodes video onto a magnetic tape in digital format with intraframe compression. DV tapes come in two formats: MiniDV and DV. Both formats record digital video compressed by a discrete cosine transform (DCT) method at 25 Megabits per second. Therefore, with regards to the resulting digital video file, this works out to roughly 3.5 MB per second. There is now a high-definition variant of DV (and MiniDV) called HDV. In terms of video quality, the DV format is a step up from consumer analog formats, such as 8 mm, VHS-C and Hi-8. Additionally, the DV format makes it straightforward to transfer the video onto computer for editing or backup purposes. For these reasons, the DV format has become a very popular format with consumers.

Digital video/versatile discs (DVDs) are optical discs having the DVD storage media format that is used for playback of digital video content with high video and sound quality, and for storing data. The increasing acceptance of different recordable DVD standards such as DVD+R/RW (R=Recordable once, RW=ReWritable), DVD-R/RW (R=Recordable once, RW=ReWritable), DVD-RAM (random access rewritable) means DVDs are often used by users to record personal video for storage and later playback.

FIG. 1 shows a DV camera 100 connected to a DVD recorder 102 for recording video stored within the DV camera 100 according to the related art. The DV camera 100 includes a DV tape 104 having video data stored therein. A recordable optical DVD 106 is coupled to the DVD recorder 102 for storing the digital video received from the DV camera 100. As shown in FIG. 1, the DVD recorder 102 receives a video signal S from the DV Camera 100. Typically, the video signal S is implemented as a high performance serial bus using a protocol such as IEEE 1394. The DVD recorder 102 receives the video signal S and records a copy of the received video content onto the DVD 106.

One of the additional features of the DVD standards is that video titles stored on a DVD may contain different “chapters” for easy navigation or to allow continuation when viewing a partially watched film. While recording a copy of the video content stored on the DV tape 104 onto the DVD 106, it is beneficial to have the DVD recorder 102 automatically record chapter marks separating the video content into different chapters. According to the related art, in order to support an automatic chapter marking function, the DVD recorder 102 of FIG. 1 further includes a timer 112. The timer 112 is utilized to measure a predetermined duration of time, which allows the DVD recorder 102 to insert a new chapter mark each time the predetermined duration of time is reached by the timer 112. For example, the video content could be partitioned into different chapters being ten minutes in duration each. Other predetermined chapter time durations in addition to user selectable time durations are also used according to the related art.

However, automatically inserting chapter marks every predetermined amount of time according to the timer 112 does not allow easy identification of different movies that may be recorded on the same DV tape 104. That is, if more than one movie is present on the DV tape 104, the start of each of the additional movies will not necessarily line up with the chapter marks on the DVD 106. Therefore, while viewing the video recorded on the DVD 106, a user will still be required to manually fast forward or rewind the playback video of the DVD 106 in order to find the exact start of one of the additional movies on the DVD 106.

### SUMMARY

According to an exemplary embodiment, a digital versatile/video (DVD) recorder is disclosed comprising a packet extractor being coupled to an incoming video signal for detecting control packets in the incoming video signal; a record start monitor being coupled to the packet extractor for monitoring a field of the control packets detected by the packet extractor, and outputting corresponding start point information according to the field; and a chapter mark insertion unit being coupled to the record start monitor for inserting chapter marks on a DVD disc being coupled to the DVD recorder when recording video onto the DVD disc according to the start point information outputted by the record start monitor.

According to another exemplary embodiment, a method of automatic chapter mark insertion for use in a digital versatile/video (DVD) recorder when recording video onto a DVD disc is disclosed. The method comprises detecting control packets in an incoming video signal; monitoring a field of the detected control packets; outputting corresponding start point information according to the field; and when recording video onto the DVD disc, inserting chapter marks on the DVD disc according to the start point information.

An exemplary embodiment of a machine-readable medium having stored thereon a plurality of instructions, the plurality of instructions including instructions which, when executed by a processor, cause the processor to perform the steps of: detecting control packets in an incoming multimedia information signal; monitoring a field of the detected control packets; outputting corresponding start point information according to the field; and when recording multimedia information onto an optical disc, inserting chapter marks on the optical disc according to the start point information.

### BRIEF DESCRIPTION OF THE DRAWINGS

FIG. 1 shows a DV camera connected to a DVD recorder for recording video stored within the DV camera according to the related art.

FIG. 2 shows a block diagram of a DVD recorder according to an exemplary embodiment.

FIG. 3 shows a first possible transition between a first movie and a second movie on the DV tape of FIG. 1.

FIG. 4 shows a second possible transition between a first movie and a second movie on the DV tape of FIG. 1.

FIG. 5 shows a third possible transition between a first movie and a second movie on the DV tape of FIG. 1.

FIG. 6 shows a flowchart describing automatic chapter mark insertion operations of a DVD recorder when recording video onto the DVD disc according to an exemplary embodiment.

FIG. 7 shows a block diagram of an embodiment of a recording system 700.

### DETAILED DESCRIPTION

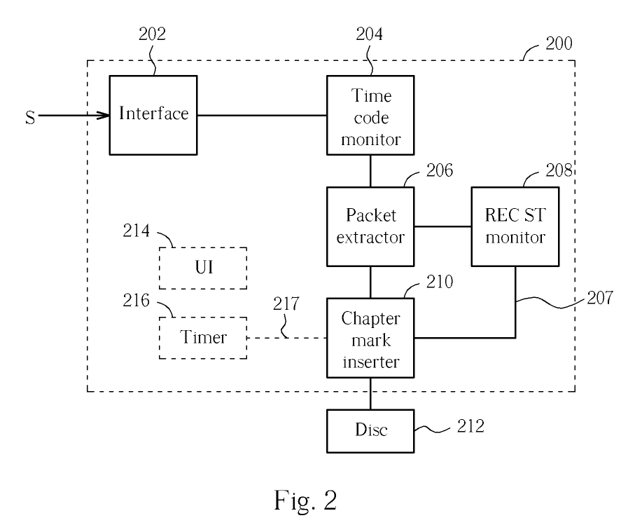

FIG. 2 shows a block diagram of a DVD recorder 200 according to an exemplary embodiment. In this embodiment, the DVD recorder 200 includes an interface circuit 202, a time code monitor 204, a packet extractor 206, a record start monitor 208, and a chapter mark insertion unit 210. The DVD recorder 200 is coupled to an optical disc 212 such as a DVD. As shown in FIG. 2, the interface 202 receives the incoming multimedia information signal S and converts the electrical characteristics of the signal S to electrical signals for internal use within the DVD recorder 200. For example, the interface 202 can be implemented as a high performance IEEE 1394 interface to receive the multimedia information signal S and convert the electrical signals of the IEEE 1394 bus to electrical signals for internal use within the DVD recorder 200. International Standard IEC 61834-4 specifies the packet header and the contents of packets that are applicable to the whole recording system of helical-scan digital video cassettes. All audio-visual data will follow the packet format defined in IEC 61834-4 and be transmitted to the receiving DVD recorder 200 on the IEEE 1394 bus.

Start point information placed in the header of every audio-visual (AV) frame is used in this embodiment to precisely locate the beginning of each movie on the DV tape 104. When recording video onto the DVD 212, the DVD recorder 200 automatically inserts chapter marks by monitoring the incoming AV frames, retrieving each frame's recording information, and determining if the frame corresponds to an exact starting position of a movie. In order to explain the automatic chapter marking operations of the DVD recorder 200 shown in FIG. 2 according to this embodiment, it is helpful to first examine the different transitions that are possible between movies on the DV tape 104.

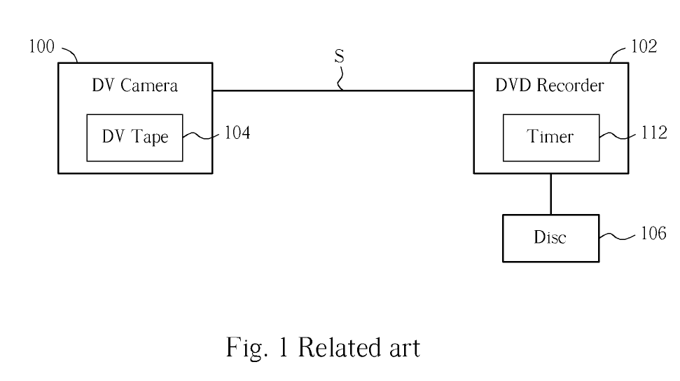

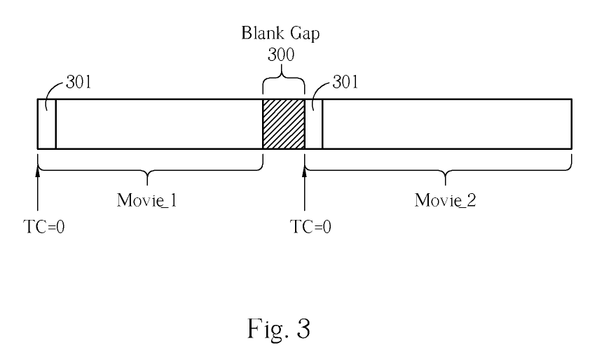

FIG. 3 shows a first possible transition between a first movie Movie_1 and a second movie Movie_2 on the DV tape 104 of FIG. 1. Many video camera recorders support audio-visual data recording on a tape or a memory card. A CARERA-TAPE mode is selected for a longer recoding time. Usually there are several segments of movies on a DV tape 104. If movies are recorded on a new tape, two adjacent sections of movies Movie_1, Movie_2 may be separated by a blank gap 300. In this situation, the two movies Movie_1, Movie_2 were recorded onto a blank area of the DV tape 104 and were caused by a user of the DV camera 100 recording the first movie Movie_1, pressing the “stop” button on the DV camera, and then later recording the second movie Movie_2. As shown in FIG. 3, the DV tape 104 includes the first movie Movie_1, a blank gap 300, and then the second movie Movie_2. The duration of the blank gap between the two adjacent movies Movie_1, Movie_2 depends on a DV setting and may be configurable by the user. An example of a typical duration of the blank gap 300 is thirty seconds. Additionally, a time code TC recorded with the video content on the DV tape 104 is reset each time the record button is pressed. Therefore, the time code TC is discontinuous between the first movie Movie_1 and the second movie Movie_2. That is, the time code TC is equal to zero at the beginning of the first movie Movie_1, and increases until the start of the second movie Movie_2 where it is again reset to zero.

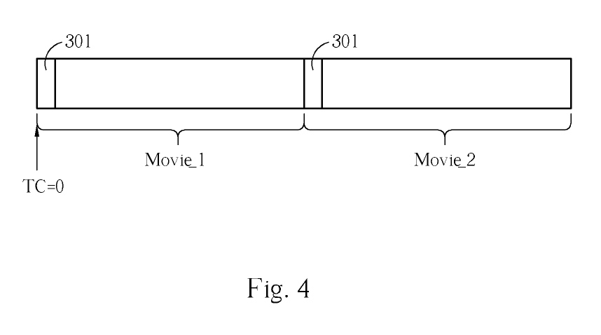

FIG. 4 shows a second possible transition between a first movie Movie_1 and a second movie Movie_2 on the DV tape 104 of FIG. 1. Sometimes, users may record a period of movie, pause the recording function and then restart it. Therefore, there is no blank gap. In this situation, the two movies Movie_1, Movie_2 were recorded onto the DV tape 104 by a user of the DV camera 100 recording the first movie Movie_1, pressing the “pause” button on the DV camera, and then pressing the “pause” button or the “record” button to continue the recording operation and begin the second movie Movie_2. As shown in FIG. 4, the DV tape 104 includes a first movie Movie_1 directly followed by a second movie Movie_2. There is no blank gap recorded on the DV tape in this situation. Additionally, the time code TC recorded with the video content on the DV tape 104 is only reset the first time the record button is pressed. Therefore, the time code TC is continuous between the first movie Movie_1 and the second movie Movie_2. That is, the time code TC is equal to zero at the beginning of the first movie Movie_1 and increases sequentially until the end of the second movie Movie_2.

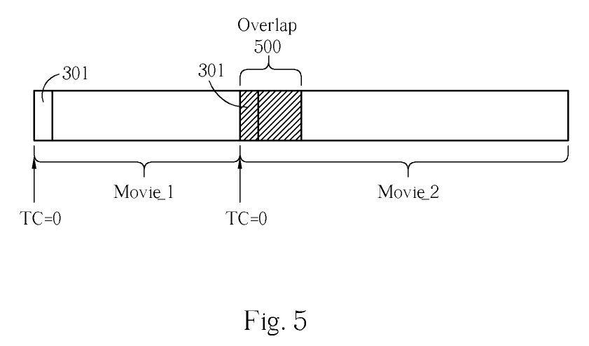

FIG. 5 shows a third possible transition between a first movie Movie_1 and a second movie Movie_2 on the DV tape 104 of FIG. 1. In another case, the recording operation starts on an already used area of a DV tape 104. The current recoding audio-visual data may overlap the previous movie as shown in FIG. 5. In this situation, the two movies Movie_1, Movie_2 were recorded by a user of the DV camera 100 recording the first movie Movie_1, pressing the “rewind” button on the DV camera, and then later recording the second movie Movie_2. As shown in FIG. 5, the DV tape 104 includes a first movie Movie_1 directly followed by a second movie Movie_2. Additionally, because the user pressed the “rewind button”, there is no blank gap between the movies, and the final portion of the first movie Movie_1 is overwritten by the initial portion of the second movie Movie_2. In other words, the second movie Movie_2 has an overlap portion 500 that replaces a portion of the first movie Movie_1. In this situation, the time code TC recorded with the video content on the DV tape 104 is reset at the beginning of the second movie Movie_2 when the “record” button is pressed. Therefore, the time code TC is discontinuous between the first movie Movie_1 and the second movie Movie_2. That is, the time code TC is equal to zero at the beginning of the first movie Movie_1, and increases until the start of the second movie Movie_2 where it is again reset to zero.

In the exemplary embodiment of the DVD recorder 200 according to FIG. 2, a new DVD chapter mark is automatically inserted at the beginning of both the first movie Movie_1 and the second movie Movie_2 for all the possible transitions between movies shown in FIG. 3 to FIG. 5. As shown in FIG. 2, the output of the interface circuit 202 is coupled to the time code monitor 204. The time code monitor 204 monitors the time code TC received within the video signal S in order to conserve space on the DVD 212. The operation of the time code monitor 204 will be explained in more detail later on in the description. Next, the packet extractor 206 detects all source control packets from the VAUX main area of the SMPTE 314-M. As will be well understood by a person of ordinary skill in the art, the DV-based data structure for the compressed stream (audio, video, sub-code, etc) of the multimedia information signal S complies with and is described by the SMPTE 314-M standard. The packet extractor 206 detects source control packets in the signal S, and passes the source control packets to the start point monitor 208.

The record start monitor 208 receives the source control packets from the packet extractor 206 and outputs start point information 207 to the chapter mark insertion unit 210. In this embodiment, the start point information 207 outputted by the record start monitor 208 corresponds to the Recording Start Point (REC ST) field of the source control packet detected by the packet extractor 206. The source control packet defined by IEC 61834-4 describes the recording information of each audio-visual frame from an AV device. The specified “REC ST” field indicates the start point of the incoming AV stream. In other words, the REC ST field indicates each time the DV camera 100 starts a recording operation. In both the situation that the record button is first pressed and the situation that an already paused record operation is un-paused, the REC ST field will be set to an asserted value for a predetermined number of frames by the DV camera 100. For example, the duration of the asserted REC ST field will typically be thirty frames for NTSC systems or twenty-five frames for PAL systems and is shown as a time duration throughout the initial frames 301 of each movie in FIG. 3, FIG. 4, and FIG. 5. The record start monitor 208 monitors this REC ST field of the source control packets, and each time the REC ST field is asserted, the record start monitor 208 asserts the start point information 207 to the chapter mark insertion unit 210.

In this embodiment, the chapter mark insertion unit 210 inserts a new chapter mark on the DVD 212 each time the start point information 207 received from the record start monitor 208 is asserted. In this way, each time a user records a new movie using the DV camera (i.e., each time a record operation is started or continued), a new chapter mark will be inserted on the DVD 212 when the DVD recorder 200 records a copy of the video. This allows the chapter navigation feature of DVDs to be used to easily find the exact beginning of each of the additional movies on the DVD.

As mentioned earlier, the time code monitor 212 is used in order to conserve space on the DVD 212. In this embodiment, the time code monitor 204 discards all frames of video data received in the multimedia information signal S that have repeated time codes TC. In this way, the time code monitor 204 will remove all so called “dummy frames” that are transmitted during the blank gap 200 shown in FIG. 2. As an added user benefit, a user interface UI 214 is included in this embodiment to indicate a message or signal to the user of the DVD recorder of when a chapter mark is being inserted and when the time code monitor 204 is discarding dummy frames.

The UI 214 can also be used as a controller for organizing the DVD recorder 200 video copying function. Before copying video recorded on a DV tape 104 of a DV camera 100, the UI 214 checks a current DV mode of the DV camera 100. If the DV camera 100 is in a Camera mode or there is no DV tape in the DV camera 100, the UI 214 immediately stops the record command. When the DV camera is ready to upload its video to the DVD recorder 200, the DVD recording procedure starts. The DV audio-visual data will be sent by a common isochronous packet (CIP) format on one isochronous channel of the IEEE 1394 bus. If both CIP and time code (TC) packets are updated, a new AV frame is allowed to pass through the time code monitor 204. The packet extractor 206 then extracts the source control packet of the received AV frame, and the record start monitor checks the REC ST field of the source control packet. When its REC ST (Recording start point) field is asserted, the beginning of a movie segment on the DV tape 104 is detected, and the chapter mark inserter 210 is informed to insert a chapter mark at this specified position on the DVD 212. The procedure is repeated until the DVD disc 212 is full or the UI 214 sends a stop command to finish the video copying.

Additionally, it should be noted that other embodiments are also possible. For example, a timer 216 can also be included in the DVD recorder 200 for use with the automatic chapter mark insertion functions. In this embodiment, the timer 216 measures a predetermined duration of time and outputs a timer signal 217 to the chapter mark insertion unit 210. In this way, the DVD recorder 102 both inserts a new chapter mark each time the REC ST field is asserted at the beginning of a new movie, and also inserts chapter marks throughout each of the movies according to the predetermined duration of time indicated by the timer signal 217.

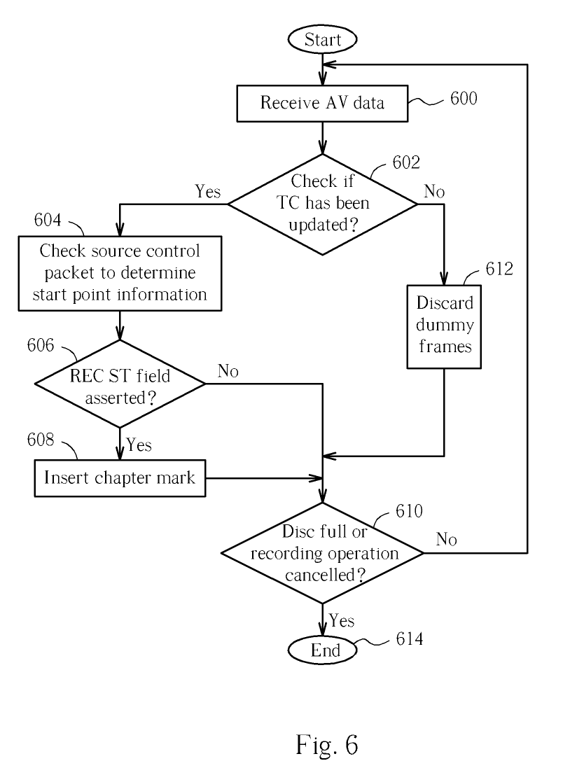

FIG. 6 shows a flowchart describing automatic chapter mark insertion operations of a DVD recorder when recording video onto the DVD disc according to an exemplary embodiment. Provided that substantially the same result is achieved, the steps of the flowchart shown in FIG. 6 need not be in the exact order shown and need not be contiguous, that is, other steps can be intermediate. In the flowchart shown in FIG. 6, automatic chapter mark insertion on a DVD recorder begins when the DV camera 100 is in the play (or VCR) mode and has a DV tape 104 loaded. The automatic chapter mark insertion operations include the following steps:

Step 600: Receive audio visual (AV) data from the DV camera 100. For example, typically the AV data is sent using the CIP format.

Step 602: Check if the time code TC field has been updated. That is, did the time code TC between the CIP packet received in step 600 and the previously received CIP packet change? If the time code TC has changed, proceed to step 604; otherwise, proceed to step 612.

Step 604: Check the source control packet in the VAUX main area to determine start point information.

Step 606: Has the recording start (REC ST) field of the source control packet changed to an asserted value? If yes, proceed to step 608; otherwise, proceed to step 610.

Step 608: Insert a chapter mark in the current DVD title on the DVD disc. The UI 214 can be used to display an indication to the user that the chapter mark is being inserted.

Step 610: Is the disc full or has the recording operation been cancelled or stopped? The UI 214 may stop the recording when the DVD 212 is full or because a user has pressed the “stop” button to cancel the copy operation. In these situations requiring stoppage, proceed to step 614; otherwise return to step 600 to repeat the operations for the next CIP packet.

Step 612: Because no new AV frame has been detected, notify the user interface UI 214 to display a message that the recording operations are paused and discard the current dummy frame.

Step 614: End automatic chapter mark insertion operations.

As previously mentioned, in another embodiment, the operations of the flowchart of FIG. 6 further include a step for measuring a predetermined duration of time and outputting a timer signal 217 when the predetermined duration of time has been reached. Additionally, a step is included for inserting a new chapter mark each time the predetermined duration of time indicated by the timer signal 217 has been reached. In this way, the start all new movie segments on the DVD will have a corresponding chapter mark, and there will be additional chapter marks every predetermined duration of time throughout each of the movies.

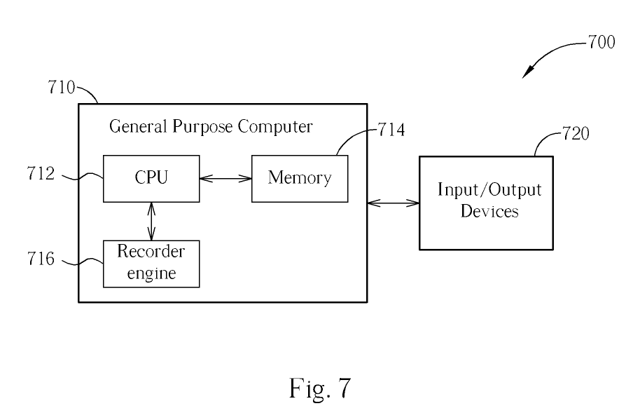

FIG. 7 shows a block diagram of an embodiment of a recording system 700. The recording system 700 comprises a general purpose computer 710 and various input/output devices 720. The general purpose computer comprises a central processing unit (CPU) 712, a memory 714, and a recorder engine 716. In some embodiments, the recorder engine 716 is simply the DVD recorder 200 as discussed earlier. The recorder engine 716 can be a physical device, which is coupled to the CPU 712 through a communication channel. Alternatively, the recorder engine 716 can be represented by a software application (or a combination of a software application and hardware, e.g., via an application specific integrated circuit (ASIC)), where the software application is loaded from a storage device, e.g., a magnetic or optical disc, and resides in the memory 714 of the computer. The CPU 712 serves to execute the software application residing in the memory 714. As such, the DVD recorder 200 can be stored on a machine-readable medium. The computer 710 can be coupled to a plurality of input and output devices 720, such as a keyboard, a mouse, a DV camera, a camcorder, a video monitor, any number of imaging devices or storage devices, including but not limited to, a tape drive, a floppy drive, a hard disk drive or a DVD disk drive.

A DVD recorder and method of automatic chapter mark insertion for use in a DVD recorder when recording video onto a DVD disc are disclosed as exemplary embodiments. The DVD recorder includes a packet extractor being coupled to an incoming video signal for detecting control packets in the incoming video signal, a record start monitor being coupled to the packet extractor for monitoring a field of the control packets detected by the packet extractor, and outputting corresponding start point information according to the field, and a chapter mark insertion unit being coupled to the record start monitor for inserting chapter marks on a DVD disc being coupled to the DVD recorder when recording video onto the DVD disc according to the start point information outputted by the record start monitor. When recording video content from a DV camera, a new chapter mark is inserted on the DVD disc for each movie on the DV camera and can be used to easily find the beginning of each movie when playing the DVD disc. This is convenient when playing back movies because the user does not need to perform a manual fast forward or rewind operation to find the exact beginning of each movie.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital versatile/video (DVD) recorder comprising:
a packet extractor being coupled to an incoming multimedia information signal for detecting control packets in the incoming multimedia information signal;
a record start monitor being coupled to the packet extractor for monitoring a field of the control packets detected by the packet extractor, and outputting corresponding start point information according to the field; and
a chapter mark insertion unit being coupled to the record start monitor for inserting chapter marks on a DVD disc being coupled to the DVD recorder when recording multimedia information onto the DVD disc according to the start point information outputted by the record start monitor.

2. The DVD recorder of claim 1, wherein the packet extractor is for detecting source control packets in the incoming multimedia information signal, and the record start monitor is for monitoring a record start (REC ST) field of the source control packets detected by the packet extractor.

3. The DVD recorder of claim 1, further comprising an interface circuit being coupled a digital video (DV) camera and the packet extractor for receiving a DV audio-visual signal from a DV camera being coupled to the DVD recorder, and for converting the DV audio-visual signal to the incoming multimedia information signal for use internally within the DVD recorder.

4. The DVD recorder of claim 3, wherein the interface circuit is an IEEE 1394 interface.

5. The DVD recorder of claim 1, further comprising a time code monitor being coupled to the incoming multimedia information signal for monitoring a time code received within the incoming multimedia information signal and discarding frames of the incoming multimedia information signal that have repeated time codes.

6. The DVD recorder of claim 5, further comprising a user interface for indicating a message or signal to a user of the DVD recorder when the time code monitor is discarding frames having repeated time codes.

7. The DVD recorder of claim 1, further comprising a user interface for indicating a message or signal to a user of the DVD recorder when the chapter mark insertion mark unit is inserting a chapter mark on the DVD disc.

8. The DVD recorder of claim 7, wherein the user interface further monitors if the DVD disc is full, and stops a DVD recording process if the DVD disc is full or if the user of the DVD recorder issues a cancel command through the user interface.

9. The DVD recorder of claim 1, further comprising a timer for measuring a predetermined duration of time and then outputting a timer signal; wherein the chapter mark insertion unit is coupled to the timer and is further for inserting chapter marks according to the predetermined duration of time indicated by the timer signal.

10. A method of automatic chapter mark insertion for use in a digital versatile/video (DVD) recorder when recording video onto a DVD disc, the method comprising:
detecting control packets in an incoming multimedia information signal;
monitoring a field of the detected control packets;
outputting corresponding start point information according to the field; and
when recording multimedia information onto the DVD disc, inserting chapter marks on the DVD disc according to the start point information.

11. The method of claim 10, wherein detecting control packet in the incoming multimedia information signal further comprises detecting source control packets in the incoming multimedia information signal, and monitoring a field of the detected control packets further comprises monitoring a record start (REC ST) field of the detected source control packets.

12. The method of claim 10, further comprising:
receiving a DV audio-visual signal from a DV camera being coupled to the DVD recorder; and
converting the DV audio-visual signal to the incoming multimedia information signal for use internally within the DVD recorder.

13. The method of claim 12, wherein the DV audio-visual signal is an IEEE 1394 serial bus signal.

14. The method of claim 10, further comprising:
monitoring a time code received within the incoming multimedia information signal; and
discarding all frames of the incoming multimedia information signal that have repeated time codes.

15. The method of claim 14, further comprising indicating a message or signal to a user of the DVD recorder when discarding frames having repeated time codes.

16. The method of claim 10, further comprising indicating a message or signal to a user of the DVD recorder when inserting a chapter mark on the DVD disc.

17. The method of claim 16, further comprising:
monitoring if the DVD disc is full; and
stopping a DVD recording process if the DVD disc is full or if the user of the DVD recorder issues a cancel command through a user interface.

18. The method of claim 10, further comprising:
measuring a predetermined duration of time and then outputting a timer signal; and
inserting a chapter mark on the DVD disc according to the predetermined duration of time indicated by the timer signal.

19. A machine-readable medium having stored thereon a plurality of instructions, the plurality of instructions including instructions which, when executed by a processor, cause the processor to perform the steps of:
detecting control packets in an incoming multimedia information signal;
monitoring a field of the detected control packets;
outputting corresponding start point information according to the field; and
when recording multimedia information onto an optical disc, inserting chapter marks on the optical disc according to the start point information.

20. The machine-readable medium of claim 19, wherein the step of detecting control packet further comprises detecting source control packets in the incoming multimedia information signal, and the step of monitoring a field of the detected control packets further comprises monitoring a record start (REC ST) field of the detected source control packets.
